(19) United States
(12) Patent Application Publication
(10) Pub. No.: US 2012/0222563 A1
(43) Pub. Date: Sep. 6, 2012

(54) LOW PRESSURE, LOW VELOCITY STEAM INJECTOR

(76) Inventors: Darrell C. Horn, Santa Rosa, CA (US); John M. Lennox, III, Sebastopol, CA (US)

(21) Appl. No.: 13/410,092

(22) Filed: Mar. 1, 2012

Related U.S. Application Data
(60) Provisional application No. 61/464,268, filed on Mar. 1, 2011.

(51) Int. Cl. A47J 36/00

(52) U.S. Cl. 99/447

(57) ABSTRACT

A direct steam injector for use in cooking food products by injecting live steam directly into the product to heat the food to cook temperatures. The injector operates under relatively low source steam manifold pressure while urging the valve return spring wide open, thus reducing the pressure of the steam flowing into the product. In addition to reducing the pressure of the steam, the steam injector reduces the velocity of the steam and better distributes it as the steam exits the injector, thereby reducing damage to the food product.

### CROSS REFERENCES TO RELATED APPLICATIONS

The present application claims the benefit of U.S. Provisional Patent Application Ser. No. 61/464,268, filed Mar. 1, 2011 (Mar. 1, 2011).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

The present invention relates most generally to steam injectors, and more particularly to steam injectors for use in food cooking apparatus, and still more particularly to a low pressure, low velocity steam injector for use in live steam injection food cooking systems.

2. Background Discussion

It is commonly known that injecting live steam into food products is a more efficient method of cooking than indirect steam heating. Even so, this method of cooking is not currently used as much as indirect steam heating in a pressurized jacket of the cooking vessel. One reason for this is that direct steam has a tendency to damage food product or cause other problems by cooking the food product too fast. Cooking food products with indirect jacket steam has several disadvantages, most notable among them being the tendency of products to burn onto the heat exchange surfaces. For this reason it is desirable to have a satisfactory direct steam injection food cooking system.

There are several different kinds of direct steam injectors, ranging from simple holes disposed in the side of the cooking vessel to very sophisticated injector mechanisms that are pneumatically or spring actuated. The most commonly used injectors close automatically in the absence of steam pressure so as to prevent food product from entering the cavity of the injector. The inside of a spring-actuated injector is a complicated mechanism with numerous moving parts, making these injectors very hard to clean, particularly if food product has infiltrated the interior spaces.

One simple automatically closed injector comprises a round ball of plastic or rubber captured within a housing and disposed over a steam port. As steam is applied to the injector, the ball is urged upward by the steam against a grating or screen at the food product interface. The elevated ball allows steam to escape from the port and functions as a baffle to disperse the steam as it rises into the product. When the steam flow is turned off, the ball will drop by gravity back onto the valve seat, and the weight of the ball will seal the seat preventing product from going into the steam piping. While simple in design, this type of ball valve is vulnerable to food product intrusion into the injector body, because only gravity maintains the ball in place on the valve seat, and this force is quite small.

Another type of direct steam injector that seals much better than the above-described ball valve is a spring-actuated valve configured much like the poppet (or “mushroom”) valves found in an internal combustion engine. It is urged into its closed position under the force of a helical compression spring. FIGS. 1A-1D schematically show an example 10 of such an apparatus. Referring first to FIG. 1A, this kind of prior art direct steam injector includes a cylindrical housing 12 having an interior void 14 in which a valve seat 16 is disposed. An end cap 18 is placed over a first end 20 of the housing 12 and captures the valve seat between an end cap cup 22 disposed on the interior side 24 of the end cap and upper interior rim 26. A sanitary gasket 28 is disposed between the end cap and the housing, and an O-ring seal 30 is disposed between the valve seat and the upper interior rim. An annular clamp 32 secures the end cap 18 to the first end 20 of the housing 12.

The valve seat 16 includes an internal through bore having a first upper diameter to accommodate a valve stem 34 and a second lower diameter, slightly larger than the first upper diameter, so as to accommodate a spring 35 coaxially disposed around the valve stem. The spring is interposed between a stem seal 36 and the ledge 38 formed at the transition from the first to the second internal bore diameter. The stem seal is disposed around a lower stem extension post 40 terminated by an expanded head 42.

The valve head 44 is securely sealed atop an exhaust chamber 46, around which are disposed a plurality of exhaust ports 48 angled inwardly and upwardly from the housing interior, through the uppermost portion of the valve seat, and into the exhaust chamber. The exhaust ports will direct steam to the underside of the valve head, and when the valve is in the operated position, through the vessel shell 50 and into the cooking chamber 52.

The housing 12 includes a steam inlet port 52 coupled to a steam supply from a manifold. These are not shown but are well known and assumed in the views. One or more pressure transfer holes 54 are disposed in the end cap cup to provide a steam flow path for steam into the cup interior 56 and under the stem seal 36. Steam injection holes 58 are provided in the valve seat so as to provide a steam flow path to and through the exhaust ports 48 to the underside 58 of the valve head 44.

Referring now to FIG. 2B, in operation as steam enters the stem inlet port it is routed along its flow path is pressurized with live steam the valve stem is pushed upward against the spring thereby compressing the spring. The movement of the valve stem moves the valve head off the valve seat and opens the valve. Steam from the steam supply also enters below the valve head and is injected into the product around the valve head through the orifice gap 62, which is the space between the valve head and the valve seat when the valve is in the open (operated) position.

This type of injector does distribute the steam in a full 360 degree direction around the valve head. Disadvantageously, however, the velocity of the steam is directly related to the steam pressure and the amount of space or orifice gap between the valve head and the valve seat. Since the spring force urging the valve to close is a function of the spring strength and spring rate of the closure spring, the valve will open to a different spacing depending on the steam supply pressure: the higher the steam supply pressure in relation to the spring force, the more the valve will open and the wider the orifice gap space for steam to escape into the product.

If the steam supply pressure is reduced, the spring will gradually, partially close, thereby reducing the orifice gap space and causing higher velocity of the steam as it escapes from the injector into the product.

When food product is damaged due to high steam pressure and steam velocity, the steam supply pressure must be reduced. However, reducing the steam supply pressure does not appreciably reduce the steam velocity, since the spring will tend to close the valve more under a lower steam pressure, thus reducing the orifice gap space where the steam flows into the product. The steam velocity is thus not reduced; only the rate at which steam is injected into the product is reduced.

Additionally, also disadvantageously, at low pressures, the valve spring in the conventional direct steam injector will begin to flutter and oscillate which results in rapidly changing velocity and considerably reduced spring life.

Finally, in standard steam injectors the velocity of the steam is very high and unusually variable around the circumference of the valve steam. These high and variable velocities cause a number of problems: First, the high shear can behave as a knife easily cutting most food products such as pasta, meats, vegetables and fruits. Second, the shear effect also decreases the droplet size of fats and water to create an emulsion of oil and water droplets. Separating the cook water from the product is virtually impossible when the fats have emulsified with the water. And third, for viscous and semi-solid food products shear can result in air entrainment and foaming.

The obvious solution to these problems is to reduce the spring rate minimizing the orifice gap so that a lower steam pressure will open the orifice gap further. It has been found, however, that this solution simply gives rise to other, equally disadvantageous problems. The lower the spring rate, the more erratic the spring becomes. It is necessary to select a spring that will close with enough force to prevent product from infiltrating the injector housing. In addition, if the spring is too soft (low spring rate), it will tend to flutter or vibrate up and down with the variation in the steam flow. If a spring with a stronger spring rate is used in combination with a low steam supply pressure, the valve will again flutter, causing reduced spring life and increased incidents of spring failure. For these reasons a spring must be selected with a high enough spring rate to be stable; yet, the spring with a higher spring rate will operate with a lower orifice gap causing higher velocity of steam being injected into the product.

Since these variables (high spring rate and low steam velocity) work counter to each other, the end result is that use of this type of direct steam injector for heating many products yields very unsatisfactory results. For example, when cooking ground beef, in order to prevent valve fluttering with enough steam supply pressure to open the valve properly, the flow of steam and steam velocity is so high that it cooks the surface of the meat too quickly, causing the meat to consolidate into large sized meatballs in which the meat in the center of the ball is uncooked. To ensure that all the meat is cooked to a temperature sufficient to kill all pathogens, the meatballs must be cooked for an excessively long time, which results in overcooked portions on the outside of the meat balls.

Furthermore, the high and variable velocities of steam form an emulsion with the condensate water and the fat as the fat melts. This results in a semi-stable water fat emulsion with entrained air within the emulsion. The emulsion formation makes the separation of water from the oil very difficult. For continuous processes where operation over long periods of time is expected, this emulsion causes concern. Cook yields and product quality decline as the water and product increases in viscosity.

In cooking another product such as pasta filata cheese (mozzarella), the pressure and temperature of the steam injected into the cheese block is critical. If the milk protein in the cheese is heated too quickly or heated with steam that is too hot, the protein denatures and gets very tough and hard. To avoid such problems, it is necessary to heat the cheese very slowly with the injected steam close to the boiling point (212 degrees F.). This is essentially impossible with a standard direct steam injector because the pressure must be high enough to open the injector and high enough to overcome the back pressure created by stiff cheese being pumped through the continuous cooker.

It is therefore desirable to have a direct steam injector that: (1) has a sufficiently strong closing spring to firmly seal the valve against the valve seat when there is no steam pressure; (2) while at the same time the steam valve must open fully at low steam pressures so that the steam being injected into sensitive products is at a low temperature and is discharged from the injector at a low velocity so that the steam is diffused evenly all the way around the valve head.

### BRIEF SUMMARY OF THE INVENTION

The present invention is an improved low pressure, low velocity direct steam injector for use in commercial and industrial cooking systems that solves the above-described problems.

It is a principal object and advantage of the present invention to reduce the required pressure of steam entering the injector needed to fully elevate and operate the valve head, while positively seating the valve head on the valve seat using a compression spring when steam pressure is absent.

To accomplish the forgoing objectives, the direct steam injector of the present invention is designed such that as steam flows into and through the injector, the steam loses pressure as it passes through steam transfer ports into an exhaust chamber under the valve head. This loss in steam pressure as steam flows through the steam transfer ports creates a high pressure area outside of the valve seat relative to the steam pressure in the exhaust chamber.

These operating advantages are achieved by providing a valve body having a novel pressure piston integral with the valve stem and disposed in an upper portion of the cylinder (or through bore) into which the valve stem is slidably disposed. The pressure piston has close clearances to optimize the driving force provided by the steam allowed to enter the upper portion of the cylinder below the pressure piston. Thus, as steam flows into the injector housing the higher pressure outside the valve seat is transferred to the underside of the pressure piston. Because the pressure under the pressure piston is higher than the pressure above the piston and in the exhaust chamber, the pressure under the piston will act with the pressure under the valve head to raise the valve at a steam pressure in the exhaust chamber lower than would be required in conventional direct steam injectors.

Further, the steam pressure in the exhaust chamber needed to fully raise the valve (and thus the steam velocity exiting from the injector into the product) can be reduced as much as desired simply by reducing the diameter of the steam transfer holes in the valve seat.

Other features, objects, and advantages of the invention will be described in the detailed description of the preferred embodiments of the invention which will form the subject matter of the claims appended hereto.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1A is a cross-sectional side view in elevation of a prior art standard spring actuated injector, showing the valve head in a closed position;

FIG. 1B is the same view showing the valve urged into an operated position and the steam flow path through the valve assembly;

FIG. 1C is a top plan view thereof of the valve seat, showing steam injection holes, partly in phantom;

FIG. 1D is a simplified schematic cross-sectional side view showing the valve seat, valve head and stem (housing and compression spring removed) of a prior art standard spring actuated injector;

FIG. 2A is cross-sectional side view in elevation of the improved low pressure, low velocity steam injector of the present invention, this view showing the valve in a closed position;

FIG. 2B is the same view showing the valve urged into an operated position and the steam flow path through the valve assembly;

FIG. 2C is a top plan view thereof, showing the improved valve seat and steam injection hole configuration; and

FIG. 2D is a simplified schematic cross-sectional side view showing the inventive steam injector valve seat, valve head and stem (housing and compression spring removed) with its salient distinctive features shown for a side-by-side comparison with the prior art standard spring actuated injector of FIGS. 1A-1D.

### DETAILED DESCRIPTION OF THE INVENTION

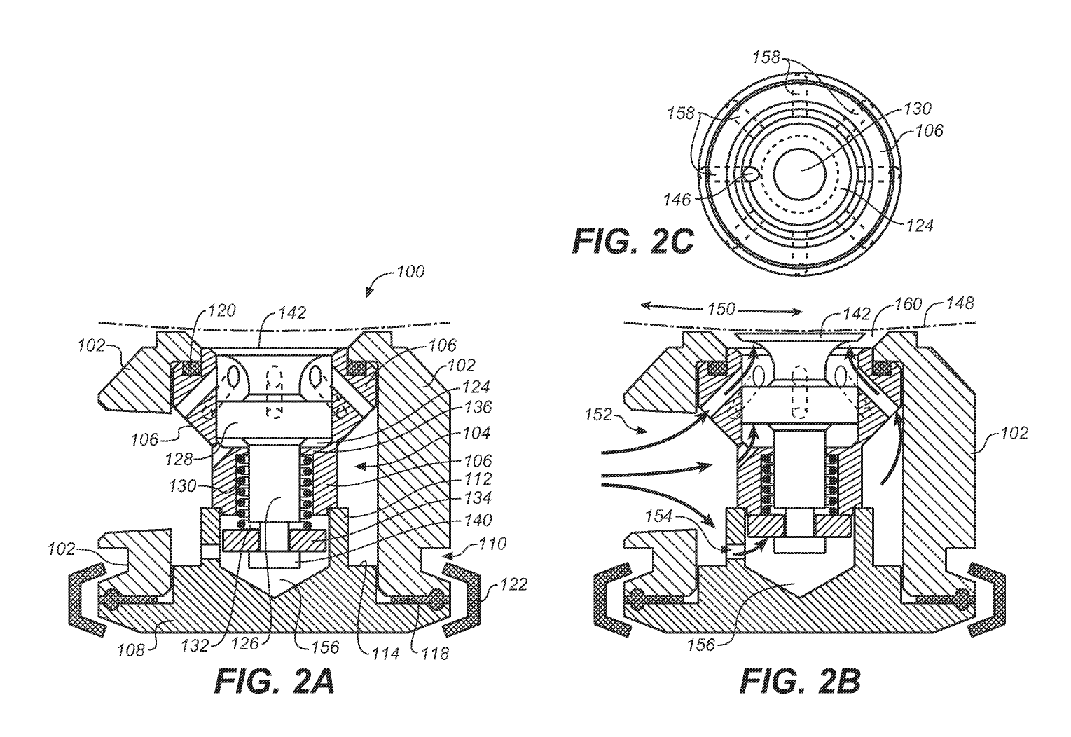

Referring to FIGS. 2A through 2D, wherein like reference numerals refer to like components in the various views, there is illustrated therein a new and improved low pressure, low velocity steam injector, generally denominated 100 herein. The drawings are described using terminology corresponding to the upright orientation of the steam injector, as shown. Accordingly, to the extent that a term such as “above” or “below” is used, it is for purposes of identifying an element or feature under discussion and better appreciating its structural or operational relationship to other features or elements.

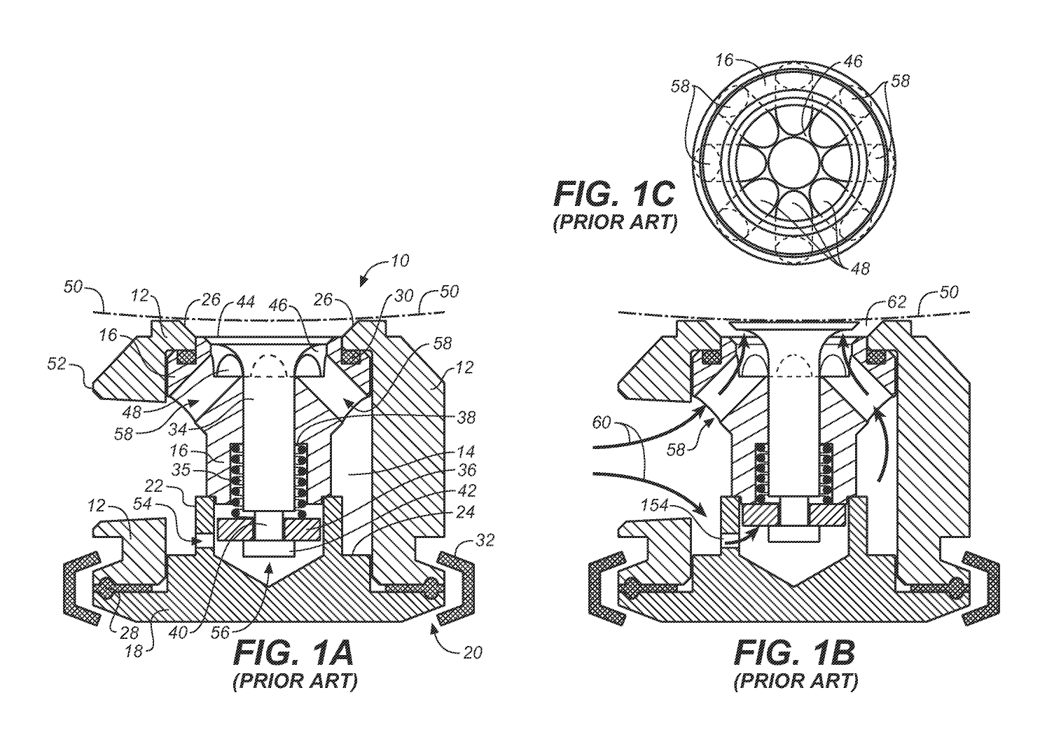

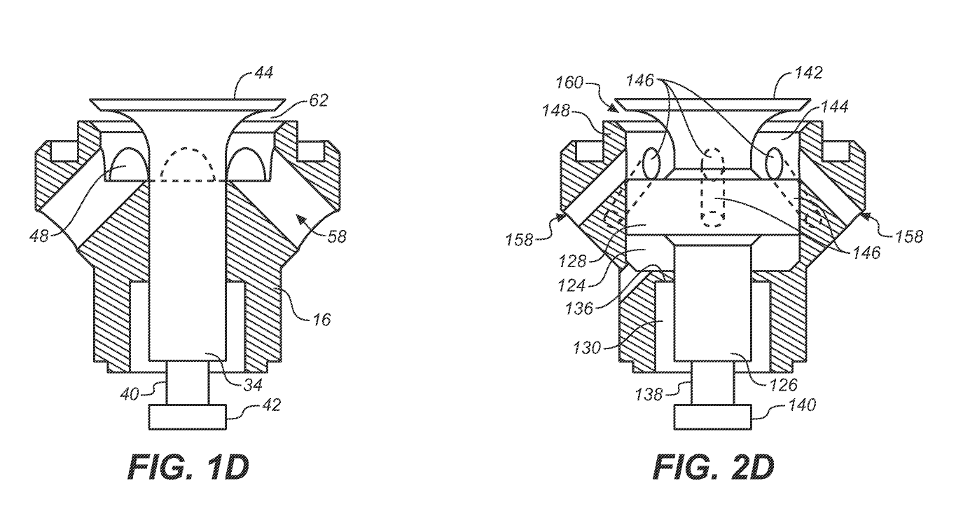

In several respects, the improved direct steam injector of the present invention resembles the prior art injector described in the preceding paragraphs and illustrated in FIGS. 1A-1D. For instance, the inventive steam injector includes a cylinder housing 102 having an interior void 104 in which a valve seat 106 is disposed. An end cap 108 is placed over a lower open end 110 of the housing 102 and captures the valve seat between an end cap cup 112 disposed on the interior side 114 of the end cap and upper interior rim 116. A sanitary gasket 118 is disposed between the end cap and the housing, and an O-ring seal 120 is disposed between the valve seat and the upper interior rim. An annular clamp 122 secures the end cap 108 to the first end 110 of the housing 102.

It is at this stage of the description that we can appreciate the salient features differentiating the inventive direct steam injector from the standard prior art steam injector. The movable element in the assembly is the valve body, which generally comprises a valve stem 126 and valve head 146. However, an upper portion of the valve stem of the present invention has been significantly modified to include a coaxially disposed annular pressure piston 128. The valve seat 106 therefore includes an internal cylindrical through bore (cylinder) having an upper portion 124 with a diameter sufficient to accommodate the pressure piston 128, which is sized with close tolerances in relation to the cylindrical side of the upper portion 124 of the through bore. The through bore also includes a lower portion 130 with a diameter slightly smaller than the upper portion, yet large enough to accommodate a spring 132 coaxially disposed around the lower stem portion of the valve body. The spring is interposed between a stem seal 134 (or stem lock washer) and a ledge 136 dividing the first portion from the second portion of the through bore. The stem seal is disposed around a lower stem extension post 138, which is terminated by an expanded head 140.

The valve head 142 is securely sealed atop a cylindrical exhaust chamber 144, around which are disposed a plurality of exhaust ports 146 angling inwardly and upwardly through the uppermost portion 148 of the valve seat to openings in the exhaust chamber. These exhaust ports direct steam to the underside of the valve head, and when the valve is in the operated position, through the vessel shell 148 and into the cooking chamber 150.

The housing 102 includes a steam inlet port 152 coupled to a steam supply from a manifold. One or more pressure transfer holes 154 are disposed in both the end cap cup 112 and in the valve seat immediately under the pressure piston to provide a steam flow path for steam into the cup interior 156 under the stem seal 134 and under the pressure piston 128. Exhaust ports 146 include steam inlet holes 158 disposed in the valve seat so as to provide a steam flow path to and through the exhaust ports 146 to the underside 160 of the valve head 142.

In operation, the inventive low pressure steam injector receives steam from the steam supply source and transfers the steam through pressure transfer holes in the end cap cup 112 into the piston chamber below the pressure piston to open the valve. The pressure of the steam in the piston chamber is the same as the steam supply pressure. The surface area of the pressure piston on which the steam pressure is applied is sufficient to compress the closure spring and open the valve at very low static pressures, thus preventing spring flutter and premature spring failure. The steam pressure against the pressure piston is also sufficient to increase the area of the orifice gap 160. However, the pressure in the exhaust chamber above the pressure piston is reduced, thereby releasing the steam into the product at a lower pressure. Because the pressure piston is forced wide open the orifice gap is large even at low steam pressures, the velocity of the steam released into the product is very low.

The steam from the steam supply source also passes through a series of exhaust ports 148 into the exhaust chamber 144 above the pressure piston 128 and is then injected into the food product. The exhaust ports are designed to create a pressure drop between the steam supply source and the exhaust chamber since the steam valve is fully open to atmosphere in the product vessel. The flow of steam from steam exhaust ports into the exhaust chamber and thereafter into the product vessel assures that the injection pressure is always lower than the pressure in the piston chamber regardless of the steam supply pressure. Therefore, the steam supply pressure can be adjusted so that the valve is fully open, yet the steam flowing into the product is at a suitably low pressure, temperature, and velocity, thus significantly reducing the damage to fragile products being heated.

Table 1 shows the benefits of this invention. The Injector Orifice gap is the space (orifice gap 160) between the operated valve head and the vale seat. As the supply pressure is increased the orifice gap is increased. However, the orifice gap is approximately 50% larger with the low velocity injector of the present invention compared with the orifice gap of the standard injector. Both injectors have identical springs with exactly the same spring rate, and the valve head and valve seat have identical dimensions and design features.

In the case of the inventive low velocity, low pressure steam injector, the steam pressure in the piston chamber is essentially the same as the steam pressure in the steam source manifold. However, the steam pressure in the exhaust chamber is substantially less due to the pressure drop in the exhaust chamber caused by the flow of steam into the product through the larger area of the orifice gap.

TABLE 1
Injector Orifice Gap

| | | Low |
|---|---|---|
| Manifold | | Velocity |
| Pressure | Standard Injector | Injector |
| 10 PSI | 0.045 inch | 0.072 inch |
| 20 PSI | 0.052 inch | 0.080 inch |
| 30 PSI | 0.060 inch | 0.090 inch |

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A spring-actuated direct steam injector for a food cooking system, comprising:
a housing having an interior void, an upper interior rim, a lower end, and a steam inlet;
a valve seat disposed within said interior void, said valve seat including an internal cylindrical through bore having an upper portion with a first diameter and a lower portion with a diameter smaller than said upper portion, a plurality of pressure transfer holes angling upwardly and inwardly through said valve seat and having steam outlets in said upper portion, a generally cylindrical exhaust chamber with a plurality of exhaust ports angling upwardly and inwardly through an uppermost portion of said valve seat from said interior void of said housing to said exhaust chamber so as to bring said exhaust chamber, said interior void, and said steam inlet into fluid communication with one another;
an end cap disposed over said lower end of said housing and capturing said valve seat between said upper interior rim and said lower end, said end cap having a cup disposed on its interior surface, said cup having at least one pressure transfer hole;
a valve body including a valve stem slidably disposed in said through bore and having a coaxially disposed annular pressure piston slidably disposed in said upper portion of said through bore above said steam outlets of said plurality of said pressure transfer holes, said pressure piston sized with close tolerances in relation to the cylindrical side of said upper portion of said through bore, and a valve head seated on said valve seat over said exhaust chamber when said valve is in a closed position, and further including a lower stem extension extending downwardly from said valve stem and terminated by an expanded head;
a stem lock washer disposed around said lower stem extension and over said expanded head; and
a compression spring coaxially disposed around said valve stem and interposed between said valve stem and the sides of said lower portion of said through bore, and further interposed between a stem seal and a ledge dividing said first portion from said second portion of said through bore;
wherein said pressure transfer holes and said exhaust ports provide a steam flow path into said interior of said cup, under said stem seal, and under said pressure piston, while said exhaust ports provide a steam flow path to and through the exhaust ports to the underside of said valve head.
